(19) United States
(12) Patent Application Publication
(10) Pub. No.: US 2020/0335016 A1
(43) Pub. Date: Oct. 22, 2020

(54) LOGO DECORATING DEVICE

(71) Applicant: Yuan Mei Corp., Chang Hua Hsien (TW)

(72) Inventor: Chi-Han Cheng, Chang Hua Hsien (TW)

(21) Appl. No.: 16/387,141

(22) Filed: Apr. 17, 2019

(51) Int. Cl. G09F 7/08; G09F 7/18

(52) U.S. Cl. CPC G09F 7/08; B05B 1/16; G09F 7/18

(57) ABSTRACT

Disclosures of the present invention describe a LOGO decorating device, which consists of a combination unit and a LOGO carrying unit. The combination unit comprises a main body for being applied to a product, and a recessed groove formed on the main body. Moreover, the LOGO carrying unit comprises a substrate, which carries with a LOGO mark on an outer surface thereon. According to the particular design of the present invention, the substrate is embedded into the recessed groove by making an inner surface of the substrate be faced to a bottom of the recessed groove. By applying this LOGO decorating device to the product, a company LOGO or a product LOGO of the product can be shown on the appearance of the product, such that any one person is facilitated to clearly recognize the LOGO from the appearance of the product.

### BACKGROUND OF THE INVENTION

### 1. Field of the Invention

The present invention relates to the technology field of water sprinklers, and more particularly to a LOGO decorating device for application in any one of different types of water sprinklers.

### 2. Description of the Prior Art

Water sprinkler is one kind of necessary device for horticultural irrigation, and which is used for wide-rangingly providing water flowing out from a faucet to the flowers, lawn, and/or trees cultivated in nursery garden. Nowadays, conventional water sprinkler have been known including water spray gun, impact water sprinkler, oscillating water sprinkler, rotary water sprinkler, and swing arm water sprinkler.

U.S. Pat. Nos. 9,073,075, 6,685,110 and 6,286,767 have disclosed three different garden sprayers. However, there are some common constituting members applied in the three garden sprayers, including handle part, sprayer head, and a connection part for pivotally connecting the handle part and the sprayer head. It is worth noting that, manufacturers or own-brand manufacturers commonly decorate their company LOGO or product LOGO on one side of the handle part or the sprayer head. However, after the garden sprayer is subject to long-term use, the LOGO decorated on the garden sprayer is found to become blurry and fail to be recognized clearly.

From above descriptions, it is understood that to redesign or develop a LOGO decorating device for decorating or combining a manufacturer's company LOGO or a product LOGO to any one of different types of water sprinklers is necessary, so as to make the company LOGO or the product LOGO can be clearly recognized by any one person from the appearance of the product of water sprinkler. In view of that, inventors of the present application have made great efforts to make inventive research and eventually provided a LOGO decorating device.

### SUMMARY OF THE INVENTION

The primary objective of the present invention is to provide a LOGO decorating device comprising a combination unit and a LOGO carrying unit. The combination unit comprises a main body for being applied to a product, and there is a recessed groove formed on the main body. On the other hand, the LOGO carrying unit comprises a substrate, which carries with a LOGO mark on an outer surface thereon. According to the particular design of the present invention, the substrate is embedded into the recessed groove by making an inner surface of the substrate be faced to a bottom of the recessed groove. By applying this LOGO decorating device to the product, a company LOGO or a product LOGO of the product can be shown on the appearance of the product, such that any one person is facilitated to clearly recognize the LOGO from the appearance of the product.

In order to achieve the primary objective of the present invention, the inventor of the present invention provides an embodiment of the LOGO decorating device, comprising:

a combination unit, comprising:
a main body;
a recessed groove, being formed on one surface of the main body; and
a first protrusion flange, being formed on a plurality of inner walls of the recessed groove, and being located around a receiving opening of the recessed groove; and
a LOGO carrying unit, comprising:
   a substrate, carrying with a LOGO mark on an outer surface thereon, and being adopted for being embedded into the recessed groove by making an inner surface of the substrate be faced to a bottom of the recessed groove; and
   a second protrusion flange, being formed around a plurality of sides of the substrate; wherein after the substrate is embedded into the recessed groove, the first protrusion flange downwardly retaining the second protrusion flange.

In the embodiment of the LOGO decorating device, the substrate and the main body are respectively made of a solid material and a flexible material, thereby making the second protrusion flange of the substrate be tightly covered and pressed by the first protrusion flange of the main body in the case of the substrate being embedded into the recessed groove.

In the embodiment of the LOGO decorating device, the LOGO mark is a pattern selected from the group consisting of: texts, alphabets, figures, symbols, graphics, and a combination of two or more of the foregoing patterns.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 shows a stereo diagram of a water sprinkler apparatus with a LOGO decorating device according to the present invention;

FIG. 2 shows an exploded view of the LOGO decorating device of the present invention;

FIG. 3 shows a stereo diagram of the LOGO decorating device;

FIG. 4 shows a stereo diagram of the LOGO decorating device;

FIG. 5 shows a cross-sectional view of the LOGO decorating device; and

FIG. 6 shows a cross-sectional view of the LOGO decorating device.

### DETAILED DESCRIPTION OF THE PREFERRED EMBODIMENTS

To more clearly describe a LOGO decorating device disclosed by the present invention, embodiments of the present invention will be described in detail with reference to the attached drawings hereinafter.

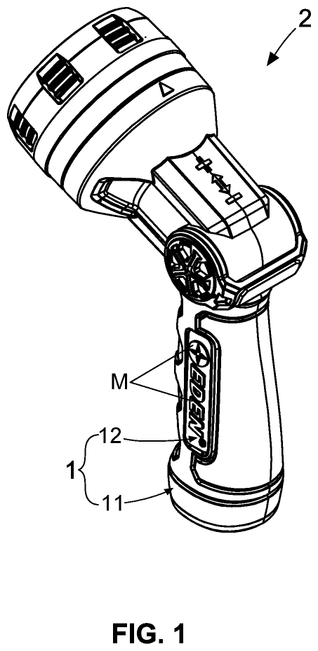

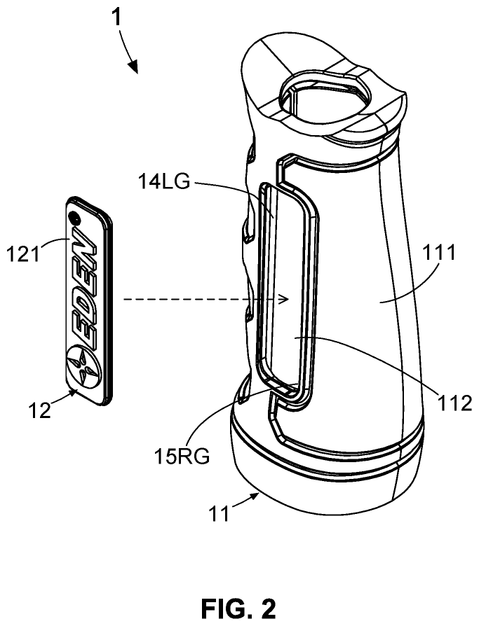

With reference to FIG. 1, there is a stereo diagram of a water sprinkler apparatus with a LOGO decorating device according to the present invention. Moreover, FIG. 1 shows an exploded view of the LOGO decorating device of the present invention. The present invention provides a LOGO decorating device 1 for application in a product 2, so as to a make a company LOGO or a product LOGO of the product 2 be shown on the appearance of the product 2, such that any one person is facilitated to clearly recognize the LOGO from the appearance of the product 2. It should be known that, the combination way for making the LOGO decorating device 1 be applied to the product 2 does not be particularly limited. For example, the LOGO decorating device 1 can be applied to the product 2 by an integral formation process, or can be attached onto the product 2 by an assembly process. As FIG. 1 and FIG. 2 show, the LOGO decorating device 1 mainly comprises a combination unit 11 and a LOGO carrying unit 12, wherein the combination unit 11 comprises a main body 111 and a recessed groove 112 formed on one surface of the main body 111.

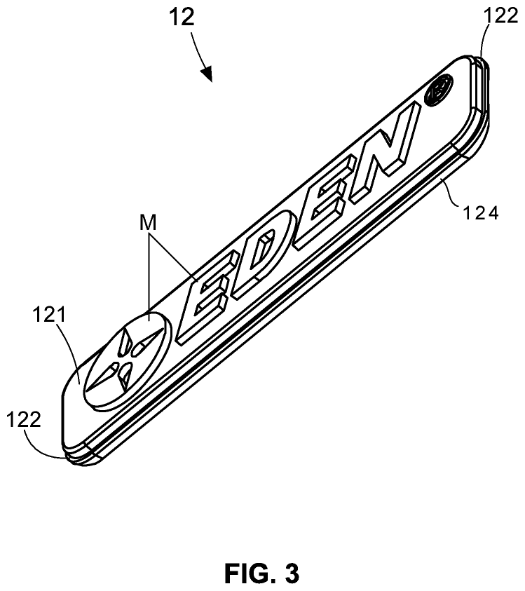

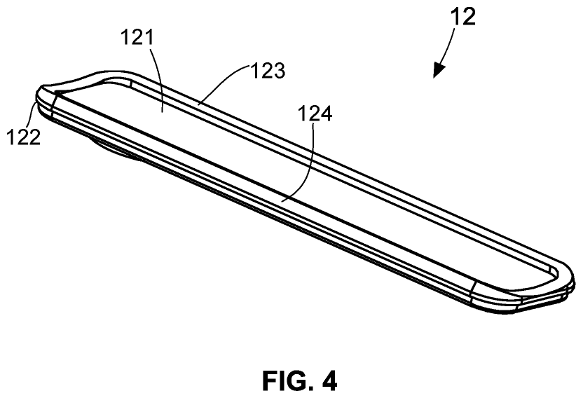

Continuously referring to FIG. 2, and please simultaneously refer to FIG. 3 and FIG. 4 respectively showing a stereo diagram of the LOGO decorating device. Particularly, a first protrusion flange 116 is formed on a plurality of inner walls of the recessed groove 112, and is located around a receiving opening of the recessed groove 112. It is worth explaining that, the center portion of a bottom of the recessed groove 112 has an extrados surface, and a first groove 14LG is formed between the bottom and one of a plurality of inner walls of the recessed groove 112. In addition, a second groove 15RG is formed between the bottom and another one of the plurality of inner walls of the recessed groove 112, so as to be opposite to the first groove 14LG under an isolation of the bottom of the recessed groove 112.

On the other hand, the LOGO carrying unit 12 has a main structure of a substrate 121, which carries with a LOGO mark M on an outer surface thereon. From FIG. 2 and FIG. 3, it is understood that the LOGO mark M can be a pattern selected from the group consisting of: texts, alphabets, figures, symbols, graphics, and a combination of two or more of the foregoing patterns. For example, LOGO mark can be a brand LOGO, a trademark, a company LOGO, or a product LOGO. Moreover, the substrate 121 is adopted for being embedded into the recessed groove 112 by making an inner surface of the substrate 121 be faced to a bottom of the recessed groove 112. It needs to further explain that, there is a second protrusion flange 122 formed around the peripheral sides of the substrate 121. On the other hand, a first protrusion member 123 is formed on the inner surface of the substrate 121, and is located at one of the peripheral sides of the substrate 121. Moreover, a second protrusion member 124 is formed on the inner surface of the substrate 121, and is located at another one of the peripheral sides of the substrate 121, so as to be opposite to the first protrusion member 123 under an isolation of the substrate 121.

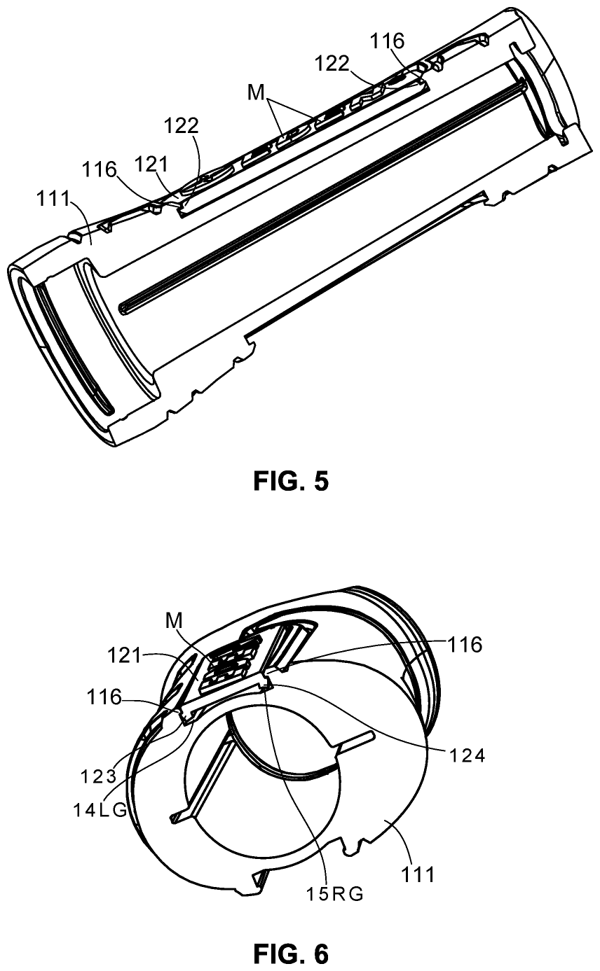

Referring to FIG. 2, FIG. 3 and FIG. 4 again, and please simultaneously refer to FIG. 5 and FIG. 6 showing respective cross-sectional diagrams of the LOGO decorating device. According to the particular design of the present invention, after the substrate 121 is embedded into the recessed groove 112, the first protrusion member 123 and the second protrusion member 124 are respectively embedded into the first groove 14LG and the second groove 15RG, and the first protrusion flange 116 downwardly retains the second protrusion flange 122. Herein it needs to further explain that, the substrate 121 and the main body 111 are respectively made of a solid material and a flexible material, thereby making the second protrusion flange 122 of the substrate 121 be tightly covered and pressed by the first protrusion flange 116 of the main body 111 in the case of the substrate 121 being embedded into the recessed groove 112. To make a detail explanation for the main body 111, according the particular design of the present invention, the main body 111, the recessed groove 112 and the first protrusion flange 116 of the combination unit 11 are all made of a flexible material.

Continuously referring to FIG. 2, FIG. 3 and FIG. 4, and please simultaneously refer to FIG. 5 and FIG. 6 showing respective cross-sectional diagrams of the LOGO decorating device.

From FIG. 5 and FIG. 6, it is found that the center portion of the bottom of the recessed groove 112 is connected between the first groove 14LG and the second groove 15RG. Moreover, from FIG. 4 and FIG. 6, it can further find that both the first protrusion member 123 and the second protrusion member 124 have an inner slant surface. It can be extrapolated that, after the substrate 121 is embedded into the recessed groove 112, both the first protrusion member 123 having inner slant surface and the second protrusion member 124 inner slant surface would reversely retain the first protrusion flange 116 formed on the plurality of inner walls of the recessed groove 112.

Therefore, through above descriptions, all constituting elements and their features and related functions of the LOGO decorating device have been introduced completely and clearly; in summary, the present invention includes the advantages of:

(1) The present invention discloses a LOGO decorating device 1, which mainly comprises a combination unit 11 and a LOGO carrying unit 12. The combination unit 11 comprises a main body 111 for being applied to a product 2, and a recessed groove 112 formed on the main body 111. Moreover, the LOGO carrying unit 12 comprises a substrate 112, which carries with a LOGO mark on an outer surface thereon. According to the particular design of the present invention, the substrate 121 is adopted for being embedded into the recessed groove 112 by making an inner surface of the substrate 121 be faced to a bottom of the recessed groove 112. By applying this LOGO decorating device 1 to the product 2, a company LOGO or a product LOGO of the product 2 can be shown on the appearance of the product 2, such that any one person is facilitated to clearly recognize the LOGO from the appearance of the product 2.

The above description is made on embodiments of the present invention. However, the embodiments are not intended to limit scope of the present invention, and all equivalent implementations or alterations within the spirit of the present invention still fall within the scope of the present invention.

1. A logo decorating device, comprising:
a combination unit, comprising:
a main body;
a recessed groove, being formed on one surface of the main body; and
a first protrusion flange, being formed on a plurality of inner walls of the recessed groove, and being located around a receiving opening of the recessed groove; and
a LOGO carrying unit, comprising:
a substrate, carrying with a LOGO mark on an outer surface thereon, and being adopted for being embedded into the recessed groove by making an inner surface of the substrate be faced to a bottom of the recessed groove; and
a second protrusion flange, being formed around a plurality of sides of the substrate; wherein after the substrate is embedded into the recessed groove, the first protrusion flange downwardly retaining the second protrusion flange, wherein the substrate and the main body are respectively made of a solid material and a flexible material, thereby making the second protrusion flange of the substrate be tightly covered and pressed by the first protrusion flange of the main body when the substrate is embedded into the recessed groove.

2. The LOGO decorating device of claim 1, wherein the combination unit further comprises:
a first groove, being formed between the bottom and one of the plurality of inner walls of the recessed groove; and
a second groove, being formed between the bottom and another one of the plurality of inner walls of the recessed groove, so as to be opposite to the first groove under an isolation of the bottom of the recessed groove.

3. The LOGO decorating device of claim 2, wherein the LOGO carrying unit further comprises:
a first protrusion member, being formed on the inner surface of the substrate, and being located at one of the plurality of sides of the substrate;
a second protrusion member, being formed on the inner surface of the substrate, and being located at another one of the plurality of sides of the substrate, so as to be opposite to the first protrusion member under an isolation of the substrate.

4. The LOGO decorating device of claim 1, wherein the main body, the recessed groove and the first protrusion flange of the combination unit are all made of flexible material.

5. (canceled)

6. The LOGO decorating device of claim 1, wherein the LOGO mark is a pattern selected from the group consisting of: texts, alphabets, figures, symbols, graphics, and a combination of two or more of the foregoing patterns.

7. The LOGO decorating device of claim 3, wherein both the first protrusion member and the second protrusion member have an inner slant surface.
